(19) United States
(12) Patent Application Publication
(10) Pub. No.: US 2023/0240809 A1
(43) Pub. Date: Aug. 3, 2023

(54) ATTACHMENT AND SHELL-SHAPED TOOTH REPOSITIONER ASSEMBLY

(71) Applicant: WUXI EA BIOTECHNOLOGY LIMITED, Jiangsu (CN)

(72) Inventors: Yikan ZHENG, Shanghai (CN); Lei HUANG, Shanghai (CN); Chuncheng ZHANG, Shanghai (CN); Ketuo ZHOU, Shanghai (CN)

(21) Appl. No.: 18/007,693

(22) PCT Filed: Mar. 15, 2021
(86) PCT No.: PCT/CN2021/080730

§ 371 Date: Dec. 1, 2022

(30) Foreign Application Priority Data
Jun. 2, 2020 (CN) 202010492080.2

(51) Int. Cl. A61C 7/36; A61C 19/04

(52) U.S. Cl. CPC A61C 7/36; A61C 19/04

(57) ABSTRACT

Disclosed is an attachment and a shell-shaped tooth repositioner assembly for repositioning a dentition from a first tooth arrangement to a second tooth arrangement, the assembly comprises a first attachment and a shell-shaped tooth repositioner, wherein the first attachment is a raised element fixed on a first tooth and forms a first force-applying surface to be applied a force thereon by the shell-shaped tooth repositioner and transferring the force to the first tooth, wherein the facing direction of the first force-applying surface is determined based on a movement tendency relative to the first tooth of a part of the shell-shaped tooth repositioner covering the first tooth, the shell-shaped tooth repositioner is an integral shell which forms a cavity receiving the dentition and a first attachment-receiving cavity receiving the first attachment, the first attachment-receiving cavity engages the first attachment when the shell-shaped tooth repositioner is worn on the dentition.

### FIELD OF THE APPLICATION

The present application generally relates to attachment and shell-shaped tooth repositioner assembly.

### BACKGROUND

Shell-shaped tooth repositioners made of polymer materials become more and more popular due to their advantages on aesthetic appearance, convenience and hygiene. An orthodontic treatment using shell-shaped tooth repositioners usually requires a series of successive shell-shaped tooth repositioners. The geometry of a cavity for receiving teeth of each shell-shaped tooth repositioner substantially matches a tooth arrangement to be achieved by a corresponding repositioning step.

In many cases, it is difficult to ensure that a repositioning force system with appropriate magnitude and direction will be applied on a tooth/teeth by a shell-shaped tooth repositioner only. For example, to move a tooth in mesial or distal direction along a dental arch, although the desired movement is translation, a large tipping torque is apt to be generated in practice, thereby causing excessive movement of the incisal edge of the tooth in the repositioning direction and thereby causing undesired tipping. In clinic practice, to avoid the above problem and apply on a tooth a repositioning force system closer to what a design target requires, it is usually necessary to additionally fix a protruding attachment having a certain shape on the tooth by a method such as adhesion, and form a corresponding cavity for receiving the attachment on the shell-shaped tooth repositioner. An auxiliary force system is applied to the tooth through squeeze and friction between the cavity and the attachment, so that the total repositioning force system applied on the tooth is closer to the desired force system. It can be seen that attachment is crucial for orthodontic treatment using shell-shaped tooth repositioners.

An attachment and a cavity for receiving the attachment of a shell-shaped tooth repositioner are independent structures, and interact with each other through squeeze and friction. Appropriately setting the adhesion position and direction of an attachment on a tooth is of great importance for generating a repositioning force system which approximates a desired force system.

### SUMMARY

In one aspect, the present application provides an attachment and a shell-shaped tooth repositioner assembly, for repositioning a dentition from a first tooth arrangement to a second tooth arrangement, which comprises a first attachment and a shell-shaped tooth repositioner, wherein the first attachment is a raised element fixed on a first tooth and forms a first force-applying surface, which is to be applied a force on by the shell-shaped tooth repositioner and to transfer the force to the first tooth, wherein the facing direction of the first force-applying surface is determined based on a movement tendency relative to the first tooth of a part of the shell-shaped tooth repositioner that covers the first tooth, the shell-shaped tooth repositioner is an integral shell which forms a cavity for receiving the dentition and a first attachment-receiving cavity for receiving the first attachment, the first attachment-receiving cavity engages the first attachment when the shell-shaped tooth repositioner is worn on the dentition.

In some embodiment, the facing direction of the first force-applying surface enables engagement between the first attachment and the shell-shaped tooth repositioner to convert the relative movement tendency therebetween into a desired force or torque.

In some embodiments, the first attachment may be used to prevent the first tooth from tipping during translation in a first direction, the first attachment may be fixed at a distal end along the first direction of a surface of the first tooth, and the facing direction of the first force-applying surface enables engagement between the first attachment and the shell-shaped tooth repositioner to convert the relative movement tendency therebetween into a torque that hinders the first tooth from tipping.

In some embodiments, an angle between the first force-applying surface and an occlusal plane of the dentition may be greater than or equal to 5° and smaller than or equal to 45°.

In some embodiments, the angle may be greater than or equal to 10° and smaller than or equal to 40°.

In some embodiments, on a plane defined by a long axis of the first tooth and a mesial-distal direction along the dental arch, a vertical distance between the top end of the contour of a projection of the first attachment and a biting edge of the contour of a projection of the first tooth is greater than or equal to 0.5 mm and smaller than or equal to 3.0 mm, and a horizontal distance between a distal-end edge along the first direction of the contour of the projection the first attachment and a distal-end edge along the first direction of the contour of the projection of the first tooth is greater than or equal to 0.5 mm and smaller than or equal to 3.5 mm.

In some embodiment, the first attachment may further forms a second force-applying surface, whose facing direction enables a force applied by the shell-shaped tooth repositioner on the second force-applying surface to generate a torque that hinders the first tooth from tipping.

In some embodiment, the geometry of the first attachment-receiving cavity may match that of the first attachment.

In some embodiment, the geometry of the cavity may match that of the dentition under the second tooth arrangement.

In another aspect, the present application provides a shell-shaped tooth repositioner, for repositioning a dentition from a first tooth arrangement to a second tooth arrangement, the shell-shaped tooth repositioner is an integral shell which forms a cavity for receiving the dentition and a first attachment-receiving cavity for receiving a first attachment fixed on a first tooth, wherein the first attachment is a raised element, the first attachment-receiving cavity engages the first attachment when the shell-shaped tooth repositioner is worn on the dentition, the facing direction of a first sidewall of the first attachment-receiving cavity, which first sidewall faces a first force-applying surface of the first attachment, is determined based on a movement tendency relative to the first tooth of a part of the shell-shaped tooth repositioner that covers the first tooth.

In some embodiment, the facing direction of the first sidewall enables engagement between the first attachment and the shell-shaped tooth repositioner to convert the relative movement tendency into a desired force or torque.

In some embodiments, the first attachment may be used to prevent the first tooth from tipping during translation in a first direction, the first attachment-receiving cavity may be located at a distal end along the first direction of a part of the shell-shaped tooth repositioner that corresponds to the first tooth, and the facing direction of the first sidewall enables engagement between the first attachment and the shell-shaped tooth repositioner to convert the relative movement tendency therebetween into a torque that hinders the first tooth from tipping.

In some embodiments, an angle between the first sidewall and an occlusal plane of the dentition may be greater than or equal to 5° and smaller than or equal to 45°.

In some embodiment, the angle may be greater than or equal to 10° and smaller than or equal to 40°.

In some embodiments, on a plane defined by a long axis of the first tooth and a mesial-distal direction along the dental arch, a vertical distance between a top end of the contour of a projection of the first attachment-receiving cavity and a biting edge of the contour of a projection of the first tooth is greater than or equal to 0.5 mm and smaller than or equal to 3.0 mm, and a horizontal distance between a distal-end edge along the first direction of the contour of the projection of the first attachment-receiving cavity and a distal-end edge along the first direction of the contour of the projection of the first tooth is greater than or equal to 0.5 mm and smaller than or equal to 3.5 mm.

In some embodiments, the first attachment-receiving cavity may further comprise a second sidewall which engages a second force-applying surface of the first attachment and whose facing direction enables generation of a torque that hinders the first tooth from tipping by a force applied by the shell-shaped tooth repositioner on the second force-applying face.

In some embodiment, a geometry of the first attachment-receiving cavity may match that of the first attachment.

In some embodiment, the geometry of the cavity may match that of the dentition under the second tooth arrangement.

In a further aspect, the present application provides a method for determining mounting position and orientation of attachment, which comprises: determining a relative movement tendency between a part of a shell-shaped tooth repositioner that covers a first tooth and the first tooth; and determining a facing direction of a first force-applying surface of a first attachment fixed on the first tooth based on the relative movement tendency, wherein the first attachment is a raised element, the first attachment and the shell-shaped tooth repositioner assembly is used for repositioning a dentition from a first tooth arrangement to a second tooth arrangement, and the shell-shaped tooth repositioner is an integral shell which forms a cavity for receiving the dentition and a first attachment-receiving cavity for receiving the first attachment.

In some embodiments, the facing direction of the first force-applying surface enables engagement between the first attachment and the shell-shaped tooth repositioner to convert the relative movement tendency into a desired force or torque.

In some embodiments, the first attachment may be used to prevent the first tooth from tipping during translation in a first direction, the first attachment may be fixed at a distal end along the first direction of a surface of the first tooth, and the facing direction of the first force-applying surface enables engagement between the first attachment and the shell-shaped tooth repositioner to convert the relative movement tendency into a torque that hinders the first tooth from tipping.

In some embodiments, the first attachment may further forms a second force-applying surface whose facing direction enables generation of a torque that hinders the first tooth from tipping by a force applied by the shell-shaped tooth repositioner on the second force-applying face.

### BRIEF DESCRIPTION OF THE DRAWINGS

The above and other features of the present application will be further illustrated below with reference to figures and their detailed description. It should be appreciated that these figures only show several exemplary embodiments according to the present application, so they should not be construed as limiting the protection scope of the present application. Unless otherwise specified, the figures are not necessarily drawn to scale, and similar reference numbers therein denote similar components.

FIG. 1 schematically illustrates a conventional design of mounting position and orientation of attachment;

FIG. 1A schematically illustrates a positional relationship between an attachment and an attachment-receiving cavity before a tooth is repositioned in the conventional design based on an assumption;

FIG. 1B schematically illustrates a positional relationship between the attachment and the attachment-receiving cavity after the tooth is repositioned in the conventional design based on an assumption;

FIG. 1C schematically illustrates an actual positional relationship between the attachment and the attachment-receiving cavity after the tooth is repositioned in one case;

FIG. 2 schematically illustrates a flow chart of a method of fabricating a shell-shaped tooth repositioner having an attachment-receiving cavity according to one embodiment of the present application;

FIG. 3A schematically illustrates a positional relationship between a tooth and a shell-shaped tooth repositioner before the tooth is repositioned in one example;

FIG. 3B schematically illustrates a positional relationship between the tooth and the shell-shaped tooth repositioner shown in FIG. 3A after the tooth is repositioned in one example;

FIG. 3C schematically illustrates an mounting position and orientation of an attachment according to one embodiment of the present application;

FIG. 3D schematically illustrates engagement between the attachment-receiving cavity of the shell-shaped tooth repositioner and the attachment in the state shown in FIG. 3B; and

FIG. 4 schematically illustrates an attachment according to one embodiment of the present application.

### DETAILED DESCRIPTION OF ILLUSTRATED EMBODIMENTS

In the following detailed description, reference is made to the accompanying drawings, which form a part thereof. Exemplary embodiments in the detailed description and figures are only intended for illustration purpose and not meant to be limiting. Inspired by the present application, those skilled in the art can understand that other embodiments may be utilized and other changes may be made, without departing from the spirit or scope of the present application. It will be readily understood that aspects of the present application described and illustrated herein can be arranged, replaced, combined, separated and designed in a wide variety of different configurations, all of which are explicitly contemplated and make part of the present application.

An orthodontic treatment using shell-shaped tooth repositioners requires a series of successive shell-shaped tooth repositioners. These shell-shaped tooth repositioners are worn sequentially to incrementally reposition a patient's dentition from an initial tooth arrangement to a first intermediate tooth arrangement, a second intermediate tooth arrangement . . . a final intermediate tooth arrangement and a target tooth arrangement.

Each shell-shaped tooth repositioner corresponds to a repositioning step and is used to reposition the patient's dentition from an initial tooth arrangement of the repositioning step to a target tooth arrangement of the repositioning step. Usually, a shell-shaped tooth repositioner is an integral shell, and forms a cavity for receiving teeth. The geometry of the cavity substantially matches a target tooth arrangement of a corresponding repositioning step. A shell-shaped tooth repositioner is fabricated based on a target tooth arrangement of a corresponding repositioning step.

In many cases, it is difficult to ensure that a repositioning force system with a proper magnitude and direction will be applied on a tooth by a shell-shaped tooth repositioner only. In such case, it is necessary to fix an attachment, which is bulgy and has a certain 3D shape, on the tooth by a method such as adhesion, and form a corresponding attachment-receiving cavity on the shell-shaped tooth repositioner. An auxiliary force system is applied on the tooth through squeeze and friction between the cavity and the attachment so that a total repositioning force system applied on the tooth is closer to a desired repositioning force system.

Currently, a conventional method of designing mounting position and orientation of an attachment on a tooth only takes into consideration absolute displacements of the accessary and the tooth on which the attachment is fixed, and assumes that a shell-shaped tooth repositioner remains in an initial state unchanged.

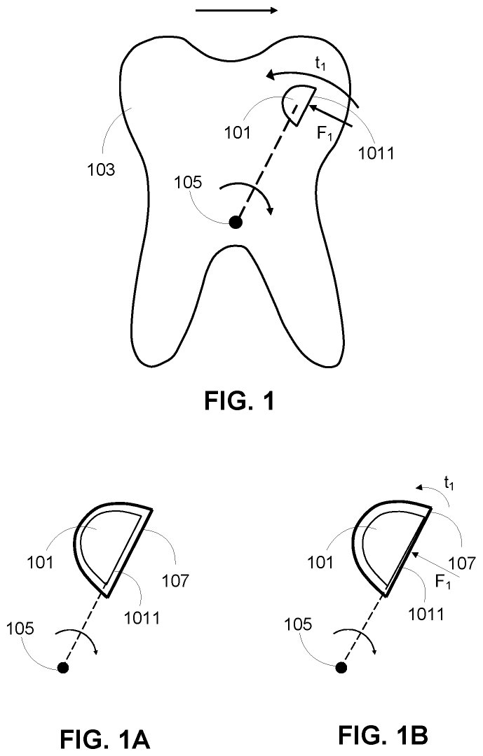

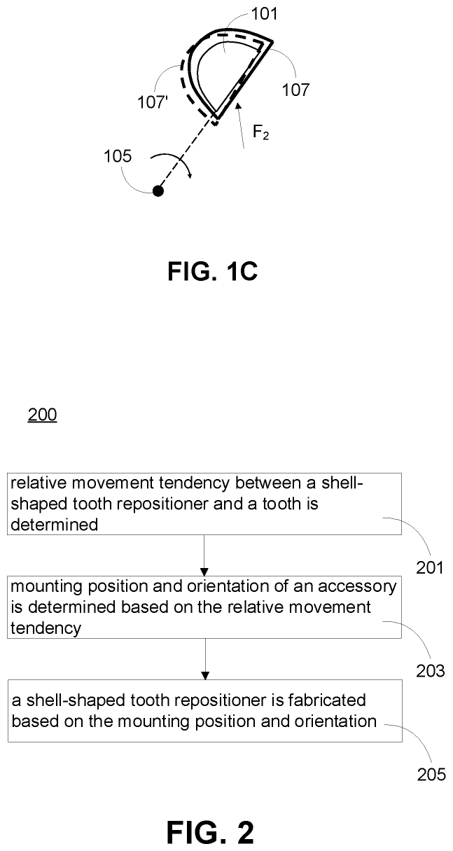

Referring to FIG. 1, it schematically illustrates a conventional design of mounting position and orientation of an attachment.

In the conventional design, an attachment 101 is an arc surface attachment with a single force-applying surface and is used to control the root and the long axis of a tooth 103 in translation. The design of the mounting position and orientation of the attachment is based on the following assumption: when the tooth 103 translates, the attachment 101 rotates about a resistance center 105 as the tooth 103 tips, and the accessary-receiving cavity of the shell-shaped tooth repositioner remains stationary during this. Therefore, the attachment 101 and the attachment-receiving cavity squeeze each other in a tangential direction of a circle along which the attachment 101 rotates about the resistance center 105. A resistance force F₁ resulted from the squeeze generates a resistance torque t₁ about the resistance center 105. To give full play to the attachment 101, the attachment 101 is mounted at a position away from the resistance center 105, i.e., at a position near the occlusal plane. Meanwhile, the facing direction of a force-applying surface 1011 of the attachment 101 is perpendicular to a line between the position of the attachment 101 and the resistance center 105.

Referring to FIG. 1A, it schematically illustrates a positional relationship between the attachment 101 and the attachment-receiving cavity 107 before the tooth 103 is repositioned based on the assumption of the conventional design. At this time, the force-applying surface 1011 of the attachment 101 does not contact a sidewall of the attachment-receiving cavity 107, i.e., the shell-shaped tooth repositioner does not apply a force on the force-applying surface 1011 of the attachment 101.

Referring to FIG. 1B, it schematically illustrates a positional relationship between the attachment 101 and the attachment-receiving cavity 107 shown in FIG. 1A after the tooth is repositioned based on an assumption of the conventional design. At this time, the force-applying surface 1011 of the attachment 101 contacts the sidewall of the attachment-receiving cavity 107, the shell-shaped tooth repositioner applies the resistance force F₁ on the force-applying surface of the attachment 101, thereby generating the corresponding resistance torque t₁ against the tipping of the tooth 103.

After extensive research and experiments, the Inventors of the present application discovered that during repositioning of a tooth by a shell-shaped tooth repositioner, not only the tooth displaces, but also some parts of the shell-shaped tooth repositioner displace due to factors such as deformation of the shell-shaped repositioner and displacement of the tooth. If the attachment-receiving cavity is within one of these parts, it is not necessary reasonable to design mounting position and orientation of the attachment based on the assumption that the attachment-receiving cavity remains stationary during the repositioning, and it is uncertain that a desired repositioning force system will be achieved.

Referring to FIG. 1C, it schematically illustrates an actual positional relationship between the attachment 101 and the attachment-receiving cavity 107 shown in FIG. 1A after the tooth 103 is repositioned in one case. In this example, the attachment-receiving cavity 107 represented by a solid line presents actual position and orientation of the attachment-receiving cavity, and the attachment-receiving cavity 107′ represented by a dashed line presents position and orientation of the attachment-receiving cavity based on the assumption of the conventional design. From FIG. 1C, it can be seen that as compared with the attachment-receiving cavity 107′, the attachment-receiving cavity 107 displaces upwards and deflects clockwise, so the resistance force actually applied by the attachment-receiving cavity 107 to the attachment 101 is F₂ which has a large deviation from the F₁ in the design shown in FIG. 1B, thereby failing to maximize the use of the attachment 101 to generate a resistance torque against the tipping of the tooth 103.

To overcome the above problems in the conventional design of attachment and shell-shaped tooth repositioner, the Inventors of the present application developed a new shell-shaped tooth repositioner having an attachment-receiving cavity, and a method of fabricating the same.

Referring to FIG. 2, it schematically illustrates a flow chart of a method 200 of fabricating a shell-shaped tooth repositioner having an attachment-receiving cavity according to one embodiment of the present application.

In 201, a relative displacement tendency between a shell-shaped tooth repositioner and a tooth is determined.

It is understood that since a shell-shaped tooth repositioner is an elastic body, relative positional relationships between parts of the shell-shaped tooth repositioner and corresponding teeth might be different between the start and end of the repositioning step. To design engagement between the attachment and the attachment-receiving cavity, it is necessary to understand the relative displacement between the surface of the tooth on which the accessary is fixed and the part of the shell-shaped tooth repositioner that covers the tooth.

In an orthodontic treatment plan using shell-shaped tooth repositioners, usually there are several repositioning steps referred to as key frames. If a movement mode of any tooth starts or ends in a repositioning step, the repositioning step is referred to as a key frame.

In one embodiment, from the start to the stop of a movement mode of a tooth, it can be considered that the relative movement tendency between the tooth and the part of the shell-shaped tooth repositioner that covers the tooth remains unchanged. Therefore, any repositioning step in the process may be selected, and the relative movement tendency between the tooth and the part of the shell-shaped tooth repositioner that covers the tooth may be determined based on the selected repositioning step.

In one embodiment, the relative movement tendency between the tooth and the part of the shell-shaped tooth repositioner that covers the tooth may be determined using a finite element analysis method.

In one example, a finite element model of a shell-shaped tooth repositioner without attachment-receiving cavity may be generated based on fabrication process data of the shell-shaped tooth repositioner using the method disclosed in the Chinese patent application No. 201710130613.0 entitled “Method of Verifying Shell-Shaped Dental Appliance Fabrication Process Based on Thermoplastic Forming Technique” filed by Wuxi EA Medical Instrument Technology Co., Ltd. on Mar. 7, 2017.

Then, the finite element model of the shell-shaped tooth repositioner without attachment-receiving cavity may be worn on a finite element model of a dentition under an initial tooth arrangement of a corresponding positioning step, to simulate interaction between the shell-shaped tooth repositioner and the teeth using the method disclosed in the Chinese patent application No. 201710286619.7 entitled “Computer-Aided Method for Testing Orthodontic Repositioning Appliance” filed by Wuxi EA Medical Instrument Technology Co., Ltd. on Apr. 27, 2017, and after a state of equilibrium is achieved, the relative displacement between any tooth and the part of the shell-shaped tooth repositioner that covers the tooth from the start to the end of the corresponding repositioning step is obtained, where the relative displacement may be taken as the relative displacement tendency between the tooth and the corresponding part of the shell-shaped tooth repositioner that covers the tooth.

In some embodiments, the relative displacement tendency between a tooth and a corresponding part of a shell-shaped tooth repositioner that covers the tooth may also be determined based on existing case data and/or experience.

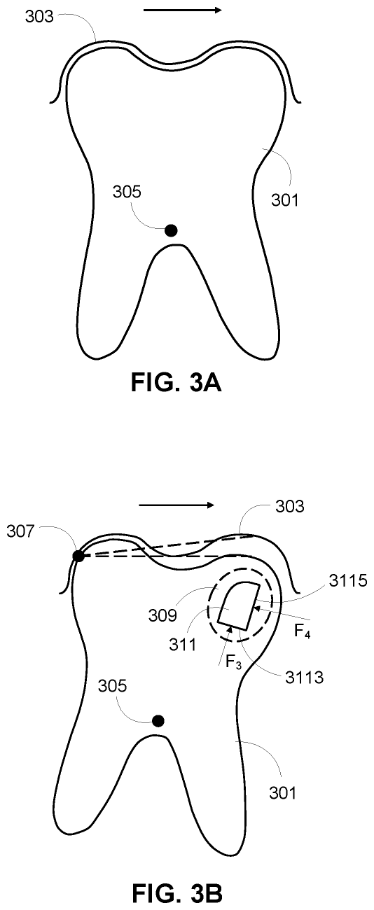

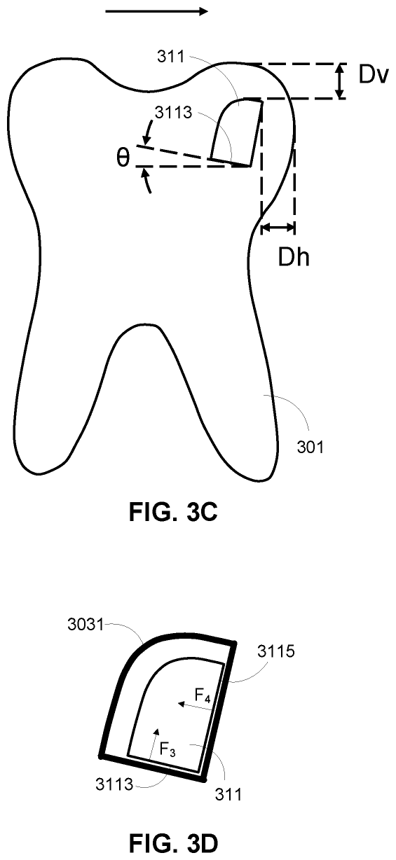

Referring to FIG. 3A, it schematically illustrates a positional relationship between a tooth 301 and a shell-shaped tooth repositioner 303 before the tooth 301 is repositioned in one example.

In one embodiment, a finite element analysis method may be used, to put a finite element model of the shell-shaped tooth repositioner 303 on a rigid finite element model (the teeth are stationary) of the dentition wherein the tooth 301 is not mounted with any attachment, and to obtain a positional relationship between the tooth 301 and the shell-shaped tooth repositioner 303 by simulation. In one example, a finite element model of a shell-shaped tooth repositioner without attachment-receiving cavity may be used.

In this example, the shell-shaped tooth repositioner 303 is designed to translate the tooth 301 rightward. During the translation of the tooth 301, it is necessary to prevent the tooth 301 from tipping (namely, rotating clockwise about the resistance center 305). To achieve this, it is necessary to mount an attachment on the tooth 301, and to form an attachment-receiving cavity at a corresponding part of the shell-shaped tooth repositioner 303. The tooth 301 is prevented from tipping during the translation through the engagement of the attachment and the attachment-receiving cavity.

Referring to FIG. 3B, it schematically illustrates a positional relationship between the tooth 301 and the shell-shaped tooth repositioner 303 shown in FIG. 3A after the tooth 301 is repositioned (by the shell-shaped tooth repositioner 303) in one example.

In one embodiment, a finite element analysis method may be used to obtain a relative displacement between the tooth 301 and the shell-shaped tooth repositioner 303 after a state of equilibrium between the dentition and the shell-shaped tooth repositioner 303 is achieved, by simulating based on a finite element model of the dentition in which the tooth 301 is not mounted with any attachment and a finite element model of the shell-shaped tooth repositioner 303, and the relative displacement may be taken as the relative displacement tendency between the tooth 301 and the shell-shaped tooth repositioner 303.

As shown in FIG. 3B, the relative displacement between the tooth 301 and the shell-shaped tooth repositioner 303 is as shown by the dashed lines, i.e., the tooth 301 rotates clockwise about a dot 307 by a certain angle. That is to say, without the attachment and the attachment-receiving cavity, the tooth 301 and the shell-shaped tooth repositioner 303 will move relatively in this way.

It is understood that if at least one component of the relative displacement tendency is constrained (e.g., constrained by the engagement of the attachment and the attachment-receiving cavity), the shell-shaped tooth repositioner will generate a rebound force along the component. In one embodiment, the attachment may be designed based on the relative displacement tendency between a tooth and the part of the shell-shaped tooth repositioner that covers the tooth, the engagement of the accessor and the attachment-receiving cavity may constrain at least one component of the relative displacement tendency, and a desired force and/or torque may be generated by the rebound force generated by the shell-shaped tooth repositioner.

In 203, attachment mounting position and orientation is determined based on the relative displacement tendency between the shell-shaped tooth repositioner and the tooth.

Referring to FIG. 3B again, there is a maximum relative displacement amount between the tooth 301 and the shell-shaped tooth repositioner at a distal end along the direction of the translation, and by mounting the attachment 311 at the distal end of the tooth 301 along the direction of the translation such as a region 309 represented by dashed line, it makes the full use of the relative displacement tendency between the tooth 301 and the shell-shaped tooth repositioner 303.

Referring to FIG. 3C, it schematically illustrates mounting position and orientation of an attachment 311 according to one embodiment of the present application.

On a plane defined by a long axis of the tooth 301 and a mesial-distal direction along the dental arch, a vertical distance between a top end of the contour of a projection of the attachment 311 and a biting edge of the contour of a projection of the tooth 301 is Dv, a horizontal distance between a distal-end along the movement direction of the contour of the projection of the attachment 311 and a distal-end along the movement direction of the contour of the projection of the tooth 301 is Dh, the attachment 311 tilts towards the translation direction of the tooth 301, and an angle between the force-applying surface 3113 and the horizontal plane (or an occlusal plane) is θ.

After extensive experiments, the Inventors of the present application discovered that when the attachment 311 is used to prevent the tooth from tilting during the translation, and good effect will be achieved when 0.5 mm≤Dv≤3.0 mm, 0.5 mm≤Dh≤3.5 mm, and 5°≤θ≤45°. In a further embodiment, when 10°≤θ≤40°, better effect will be achieved.

In one embodiment, the attachment 311 shown in FIG. 3B may be used, it has two force-applying surfaces 3113 and 3115 that are substantially perpendicular to each other.

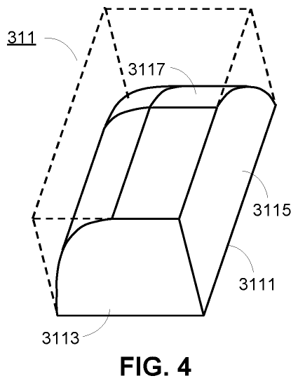

Referring to FIG. 4, it schematically illustrates the attachment 311 shown in FIG. 3B.

The attachment 311 is a closed 3D body enclosed by a bottom surface 3111, adjoining force-applying surfaces 3113 and 3115, and a guiding surface 3117.

The attachment 311 is fixed on a tooth via the bottom surface 3111, for example, by adhesion. Therefore, the bottom surface 3111 may also be referred to as mounting surface. In the present embodiment, the contour of the bottom surface 3111 is substantially rectangular.

In one embodiment, the bottom surface 3111 may be a concave arc surface to receive more adhesive, thereby better fixing the attachment 100a on the tooth.

In one embodiment, structures for reinforcing adhesion, for example, a plurality of bumps and/or dimples, may be formed on the bottom surface 3111 to increase a surface area of the bottom surface 3111 in contact with the adhesive, thereby better fixing the attachment 311 on the tooth.

The force-applying surfaces 3113 and 3115 are provided for the shell-shaped tooth repositioner to apply forces, and the attachment 311 transfer these forces to the tooth on which the attachment 311 lies. The force-applying surfaces 3113 and 3115 are adjoined, and the angles between them and the bottom surface 3111 are steep which is helpful for the shell-shaped tooth repositioner to apply forces thereon.

In one embodiment, the force-applying surfaces 3113 and 3115 are planes, perpendicular to each other, and parallel to the normal direction of the bottom surface 3111.

The guiding surface 3117 is to guide the attachment-receiving cavity of the shell-shaped tooth repositioner to get in position and catch the attachment 311. Therefore, the angle between the guidance surface 3117 and the bottom surface 3111 is gentle which is helpful for the shell-shaped tooth repositioner to be put on and removed. The guiding surface 3117 may comprise a plurality of regions, and each region may have a different geometry. For example, a part of the guiding surface 3117 opposite to the force-applying surface 3115 is an arc surface, a part of the guiding surface 3117 opposite to the force-applying surface 3113 is also an arc surface, and a part of the guidance surface 3117 opposite to the bottom surface 3111 is a plane.

A part of the guiding surface 3117 is directly adjoined with the bottom surface 3111, and the remaining part of the guidance surface 3117 is connected with the bottom surface 3111 via the two adjoining force-applying surfaces 3113 and 3115.

In one embodiment, the attachment 311 may be solid. In another embodiment, the attachment 311 may be hollow.

To prevent the tooth 301 from tipping during translation rightward, the attachment 311 may be fixed according to the following: the facing direction of the force-applying surface 3113 is opposite to a tangential direction of the tendency of rotation of the shell-shaped tooth repositioner 303 about the point 307 relative to the tooth 301 (or opposite to the tendency of the movement of the shell-shaped tooth repositioner 303 relative to the tooth 301 at the position where the attachment 311 is fixed).

Referring to FIG. 3D, it schematically illustrates the engagement between the attachment-receiving cavity 3031 of the shell-shaped tooth repositioner 303 and the attachment 311. The attachment 311 is fixed according to the above. On the one hand, when the tooth 301 begins to tip, the sidewall of the attachment-receiving cavity 3031 abuts against the force-applying surface 3113, and the movement tendency of the shell-shaped tooth repositioner 303 relative to the tooth 301 drives the sidewall of the attachment-receiving cavity 3031 to generate on the force-applying force 3113 a force F₃ perpendicular to the force-applying surface 3113. A torque generated by the force F₃ and having the resistance center 305 as its center is opposite to the tipping direction of the tooth 301, therefore the torque is able to resist the tipping of the tooth 301. On the other hand, when the tooth 301 begins to tip, the sidewall of the attachment-receiving cavity 3031 abuts against the force-applying surface 3115, and the movement tendency of the shell-shaped tooth repositioner 303 relative to the tooth 301 drives the sidewall of the attachment-receiving cavity 3031 to generate on the force-applying force 3115 a force F₄ perpendicular to the force-applying surface 3115. A torque generated by the force F₄ and having the resistance center 305 as its center is opposite to the tipping direction of the tooth 301, the torque is able to resist the tipping of the tooth 301 as well. In this example, it makes the full use of the displacement tendency of the shell-shaped tooth repositioner 303 relative to the tooth 301 to resist the tipping of the tooth.

It is understood that an attachment solution includes selection of attachment type and determination of mounting position and orientation. To achieve similar goals, mounting positions and orientations of accessories of different shapes/types might be different.

In 205, the shell-shaped tooth repositioner is fabricated based on the mounting position and orientation of the attachment.

In one embodiment, after the mounting position and orientation of the attachment is determined, a 3D digital model of the attachment may be added on a corresponding dentition 3D digital model (e.g., a 3D digital model representing a target tooth arrangement of a corresponding repositioning step), and then the dentition 3D digital model comprising the attachment is used to control an apparatus to fabricate the shell-shaped tooth repositioner.

In one embodiment, the dentition 3D digital model comprising the attachment is first used to control an apparatus to fabricate a positive model (e.g., fabricate the positive model using a stereolithography technique), and then form the shell-shaped tooth repositioner on the positive model using a thermoplastic forming technique.

It is understood that the interaction/engagement between the attachment-receiving cavity 3031 and the attachment 311 depends on the mounting position and orientation of the attachment 311 on the tooth 301 and the position and orientation of the attachment-receiving cavity 3031 on the shell-shaped tooth repositioner 303. After the mounting position and orientation of the attachment 311 on the tooth 301 is determined, the shell-shaped tooth repositioner 303 may be fabricated directly based on the mounting position and orientation (i.e., the position and orientation of the attachment on the 3D digital model for fabricating the shell-shaped tooth repositioner 303 is unchanged), or the position and orientation of the attachment on the 3D digital model for fabricating the shell-shaped tooth repositioner 303 may be adjusted based on a desired force system to be achieved.

In one embodiment, an attachment solution may be tested using finite element analysis or a platform for measuring forces applied on teeth (e.g., the platform for measuring forces applied on teeth disclosed in the Chinese patent application No. 201610990813.9 entitled “Apparatus and Method for measuring forces applied on teeth” filed by Wuxi EA Medical Instrument Technology Co., Ltd. on Nov. 10, 2016).

In the above embodiments, the force-applying surfaces 3111 and 3113 of the attachment 311 are adjoined and perpendicular to each other. However, in some cases, it might not be an optimal configuration that the force-applying surfaces 3111 and 3113 are perpendicular to each other. Therefore, in one embodiment, the orientations of the force-applying surfaces 3111 and 3113 (or an angle between the force-applying surfaces 3111 and 3113) may be determined according to a direction of a force or a torque to be generated.

While various aspects and embodiments have been disclosed herein, other aspects and embodiments will be apparent to those skilled in the art, inspired by the present application. The various aspects and embodiments disclosed herein are for illustration only and are not intended to be limiting, and the scope and spirit of the present application shall be defined by the following claims.

Likewise, the various diagrams may depict exemplary architectures or other configurations of the disclosed methods and systems, which are helpful for understanding the features and functions that can be included in the disclosed methods and systems. The claimed invention is not restricted to the illustrated exemplary architectures or configurations, and desired features can be achieved using a variety of alternative architectures and configurations. Additionally, with regard to flow diagrams, functional descriptions and method claims, the order in which the blocks are presented herein shall not mandate that various embodiments of the functions shall be implemented in the same order unless otherwise the context specifies.

Unless otherwise specifically specified, terms and phrases used herein are generally intended as “open” terms instead of limiting. In some embodiments, use of phrases such as “one or more”, “at least” and “but not limited to” should not be construed to imply that the parts of the present application that do not use similar phrases intend to be limiting.

We claim:

1. An attachment and a shell-shaped tooth repositioner assembly, for repositioning a dentition from a first tooth arrangement to a second tooth arrangement, comprising a first attachment and a shell-shaped tooth repositioner,
wherein the first attachment is a raised element fixed on a first tooth and forms a first force-applying surface, which is to be applied a force on by the shell-shaped tooth repositioner and to transfer the force to the first tooth, the facing direction of the first force-applying surface is determined based on a movement tendency relative to the first tooth of a part of the shell-shaped tooth repositioner that covers the first tooth, and
the shell-shaped tooth repositioner is an integral shell which forms a cavity for receiving the dentition and a first attachment-receiving cavity for receiving the first attachment, the first attachment-receiving cavity engages the first attachment when the shell-shaped tooth repositioner is worn on the dentition.

2. The assembly of claim 1, wherein the facing direction of the first force-applying surface enables engagement between the first attachment and the shell-shaped tooth repositioner to convert the relative movement tendency into a desired force or torque.

3. The assembly of claim 2, wherein the first attachment is used to prevent the first tooth from tipping during translation in a first direction, the first attachment is fixed at a distal end along the first direction of a surface of the first tooth, and the facing direction of the first force-applying surface enables engagement between the first attachment and the shell-shaped tooth repositioner to convert the relative movement tendency into a torque that hinders the first tooth from tipping.

4. The assembly of claim 3, wherein the first attachment tilts towards the first direction, and an angle between the first force-applying surface and an occlusal plane of the dentition is greater than or equal to 5° and smaller than or equal to 45°.

5. The assembly of claim 4, wherein the angle is greater than or equal to 10° and smaller than or equal to 40°.

6. The assembly of claim 3, wherein on a plane defined by a long axis of the first tooth and a mesial-distal direction along a dental arch, a vertical distance between a top end of the contour of a projection of the first attachment and a biting edge of the contour of a projection of the first tooth is greater than or equal to 0.5 mm and smaller than or equal to 3.0 mm, and a horizontal distance between a distal-end edge along the first direction of the contour of the projection of the first attachment and a distal-end edge along the first direction of the contour of the projection of the first tooth is greater than or equal to 0.5 mm and smaller than or equal to 3.5 mm.

7. The assembly of claim 3, wherein the first attachment further forms a second force-applying surface whose facing direction enables a force applied by the shell-shaped tooth repositioner on the second force-applying face to generate a torque that hinders the first tooth from tipping.

8. The assembly of claim 1, wherein the geometry of the first attachment-receiving cavity matches that of the first attachment.

9. The assembly of claim 1, wherein the geometry of the cavity for receiving the dentition matches that of the dentition under the second tooth arrangement.

10. A shell-shaped tooth repositioner, for repositioning a dentition from a first tooth arrangement to a second tooth arrangement, wherein the shell-shaped tooth repositioner is an integral shell which forms a cavity for receiving the dentition and a first attachment-receiving cavity for receiving a first attachment fixed on a first tooth, wherein the first attachment is a raised element, the first attachment-receiving cavity engages the first attachment when the shell-shaped tooth repositioner is worn on the dentition, the facing direction of a first sidewall of the first attachment-receiving cavity, which first sidewall faces a first force-applying surface of the first attachment, is determined based on a movement tendency relative to the first tooth of a part of the shell-shaped tooth repositioner that covers.

11. The shell-shaped tooth repositioner of claim 10, wherein the facing direction of the first sidewall enables engagement between the first attachment and the shell-shaped tooth repositioner to convert the relative movement tendency into a desired force or torque.

12. The shell-shaped tooth repositioner of claim 11, wherein the first attachment is used to prevent the first tooth from tipping during translation in a first direction, the first attachment-receiving cavity is located at a distal end along the first direction of a part of the shell-shaped tooth repositioner that corresponds to the first tooth, and the facing direction of the first sidewall enables engagement between the first attachment and the shell-shaped tooth repositioner to convert the relative movement tendency into a torque that hinders the first tooth from tipping.

13. The shell-shaped tooth repositioner of claim 12, wherein an angle between the first sidewall and an occlusal plane of the dentition is greater than or equal to 5° and smaller than or equal to 45°.

14. The shell-shaped tooth repositioner of claim 13, wherein the angle is greater than or equal to 10° and smaller than or equal to 40°.

15. The shell-shaped tooth repositioner of claim 12, wherein on a plane defined by a long axis of the first tooth and a mesial-distal direction along the dentition, a vertical distance between a top end of the contour of a projection of the first attachment-receiving cavity and a biting edge of the contour of a projection of the first tooth is greater than or equal to 0.5 mm and smaller than or equal to 3.0 mm, and a horizontal distance between a distal-end edge along the first direction of the contour of the projection of the first attachment-receiving cavity and a distal-end edge along the first direction of the contour of the projection of the first tooth is greater than or equal to 0.5 mm and smaller than or equal to 3.5 mm.

16. The shell-shaped tooth repositioner of claim 12, wherein the first attachment-receiving cavity further comprises a second sidewall which engages a second force-applying surface of the first attachment and whose facing direction enables a force applied by the shell-shaped tooth repositioner on the second force-applying force to generate a torque that hinders the first tooth from tipping.

17. The shell-shaped tooth repositioner of claim 12, wherein the geometry of the first attachment-receiving cavity matches that of the first attachment.

18. The shell-shaped tooth repositioner of claim 12, wherein the geometry of the cavity for receiving the dentition matches that of the dentition under the second tooth arrangement.

19. A method for determining mounting position and orientation of an attachment, comprising:
determining a relative movement tendency between a part of a shell-shaped tooth repositioner that covers a first tooth and the first tooth; and
determining the facing direction of a first force-applying surface of a first attachment fixed on the first tooth based on the relative movement tendency,
wherein the first attachment is a raised element, the first attachment and the shell-shaped tooth repositioner assembly is for repositioning a dentition from a first tooth arrangement to a second tooth arrangement, the shell-shaped tooth repositioner is an integral shell which forms a cavity for receiving the dentition and a first attachment-receiving cavity for receiving the first attachment.

20. The method of claim 19, wherein the facing direction of the first force-applying surface enables engagement between the first attachment and the shell-shaped tooth repositioner to convert the relative movement tendency into a desired force or torque.

21. The method of claim 20, wherein the first attachment is used to prevent the first tooth from tipping during translation in a first direction, the first attachment is fixed at a distal end along the first direction of a surface of the first tooth, and the facing direction of the first force-applying surface enables engagement between the first attachment and the shell-shaped tooth repositioner to convert the relative movement tendency into a torque that hinders the first tooth from tipping.

22. The method of claim 21, wherein the first attachment further forms a second force-applying surface whose facing direction enables generation of a torque that hinders the first tooth from tipping by a force applied by the shell-shaped tooth repositioner on the second force-applying face.
